(19) United States
(12) Patent Application Publication
(10) Pub. No.: US 2024/0425121 A1
(43) Pub. Date: Dec. 26, 2024

(54) REAR TIRE CARRIER

(71) Applicant: ONE-T, LLC, Sycamore, IL (US)

(72) Inventor: Brian Mathews, Sycamore, IL (US)

(21) Appl. No.: 18/212,829

(22) Filed: Jun. 22, 2023

(51) Int. Cl. B62D 43/02

(52) U.S. Cl. CPC B62D 43/02

(57) ABSTRACT

A rear tire carrier device for mounting a spare tire to a vehicle swing gate or tailgate. The carrier device is mounted directly to the gate and includes a pivot point to open same allowing full use of the gate irrespective of gate positioning.

### CROSS-REFERENCE TO RELATED APPLICATION

None.

### BACKGROUND OF THE INVENTION

### I. Field of the Invention

The present disclosure relates generally to spare tire carrying devices, and more specifically to a device mounted on a vehicle tailgate or a swing gate allowing full use of the gate.

### II. Description of the Prior Art

Certain vehicles, including but not limited to pick-up trucks and SUVs, have a spare tire mounted on the tailgate or swing gate. These OEM spare tire mounts are typically cumbersome and quite difficult to maneuver. By way of example, the position of the mount and the weight of the spare make use insurmountable for many solo users and as such these mounts are best handled by two people. Indeed, the problems associated with manufacturer spare tire mounts have spawned a variety of aftermarket spare tire mount solutions.

One such solution is the so-called static spare tire carrier. These include heavier hinges and associated support for the added weight of off-road tires. While there are many varieties of this style, and the user can still use the tailgate as intended, he must still lift the spare tire and attach it to the carrier, risking injury.

Another solution is the side swing tire carrier. However, the user must lift the tire into place and secure, again risking injury. The user must also open the spare tire side swing support to access the tailgate and use it.

The lower pivot point solution is the so-called swing down tire carrier. Here the user rolls the spare tire into the carrier, mounts it therein, and lifts it into position. While easier for the solo user, the pivot location of these carriers are attached to the bumper, and as such the user has no ability to use the tailgate without lowering the spare tire carrier.

The present disclosure overcomes the problems associated with the aforementioned OEM spare tire mounts as well as currently available options to alleviate the problems. Accordingly, it is a general object of this disclosure to provide a rear tire carrier to address these problems.

It is another general object of the present disclosure to provide an aftermarket rear tire carrier for rear tailgate and swing gate mounted spare tire vehicles.

It is a more specific object of the present disclosure to provide a tire carrier that allows the user to easily remove/install the spare tire onto the carrying device.

It is another object of the present disclosure to provide a tire carrier that allows the user to easily use the swing gate or the tailgate.

Yet another object of the present disclosure is to provide a tire carrier that makes the mounting of the spare tire easy and does not create injury by lifting the weight of the spare tire assembly.

Still another object of the present disclosure is to provide a tire carrier that supports the swing gate or tailgate from the added weight of a spare tire assembly, especially off-road tires.

These and other objects, features and advantages of this disclosure will be clearly understood through a consideration of the following detailed description.

### SUMMARY OF THE INVENTION

According to an embodiment of the present disclosure, there is provided a device for carrying a spare tire on a vehicle rear gate including a tire assembly coupled to the gate whereby the assembly is sized to enclose a spare tire and has an open position and a closed position. When in the closed position the tire is secured and when in the open position the assembly pivots to allow full access of the gate regardless of assembly position.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a rear perspective view of an exemplar vehicle including the tire carrier device according to the principles of an embodiment of the present disclosure.

FIG. 2 is an enlarged view of the tire carrier device of FIG. 1.

FIG. 3 is a rear perspective view of the tire carrier device of FIG. 1 in the loading/unloading position.

FIG. 4 is a side view of FIG. 3.

FIG. 5 is a side view of FIG. 3 with the tire removed.

FIG. 6 is a perspective view of the rear tire carrier device according to the principles of the present disclosure.

FIG. 7 is a perspective view of the tire carrier device of FIG. 6 in the unlocked position.

FIG. 8 is a perspective view of the rear tire carrier device of FIG. 6 in the fully open and receiving position.

FIG. 9 is a perspective view of the rear tire carrier device of FIG. 6 detached from an exemplar vehicle.

FIG. 10 is a perspective view of the rear tire carrier device of FIG. 6 attached to the exemplar vehicle.

FIG. 11 is an enlarged view of the tire carrier device of FIG. 10.

FIG. 12 is a side view of an alternate embodiment of the tire carrier device according to the principles of the present disclosure.

FIGS. 13A and 13B are side views of an alternate embodiment of the tire carrier device according to the principles of the present disclosure.

FIGS. 14A and 14B are side views of an alternate embodiment of the tire carrier device according to the principles of the present disclosure.

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

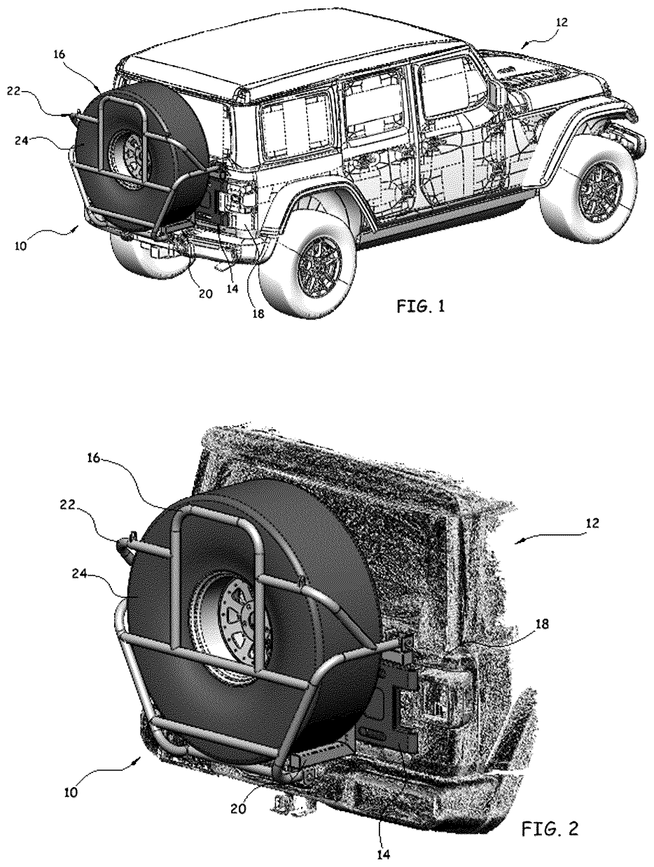

Turning now to the figures, and in particular to FIGS. 1 and 2, an embodiment of the tire carrier device 10 is illustrated mounted to an exemplar vehicle 12 in the perspective view. The main component parts of the carrier include a gate support assembly 14 and a spare tire assembly 16. The gate support assembly 14 attaches to the tailgate or swing gate of the vehicle. For purposes of this embodiment, the gate support assembly 14 is attached to a swing gate 18 of the vehicle 12. The spare tire assembly 16 includes a support arm frame 20 and a tire carrier frame 22. Here the tire assembly is in the closed state and the tire 24 is shown secured in the stored or transport position.

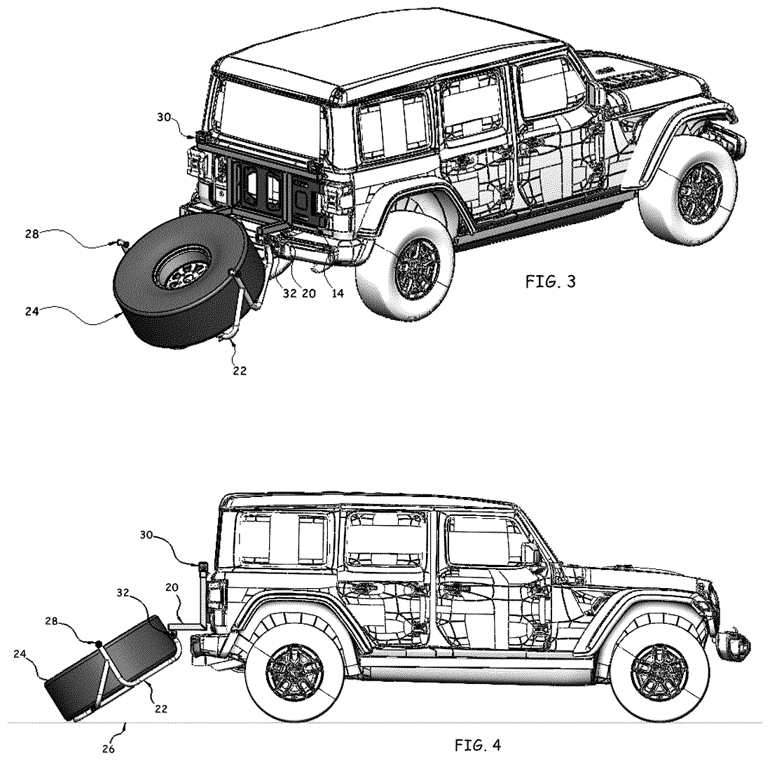

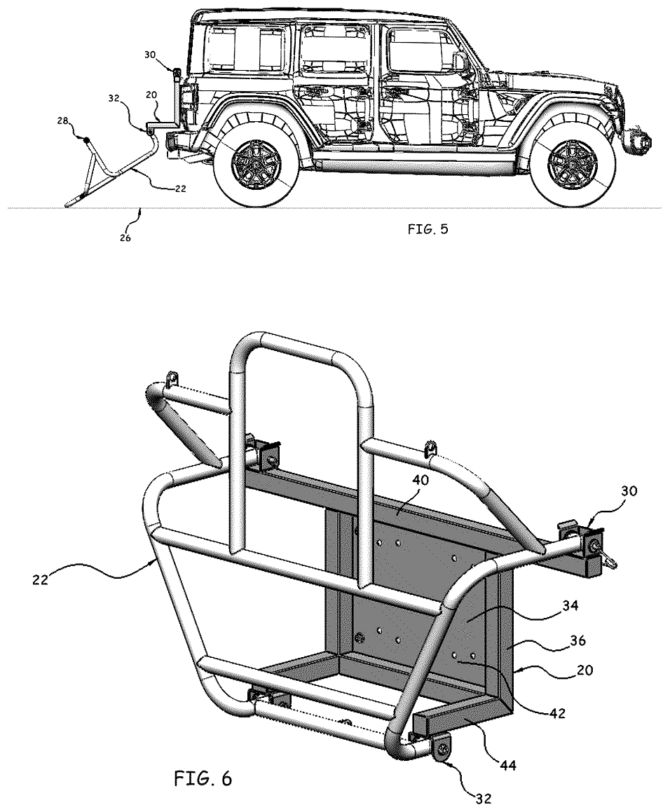

In the event the tire 24 is to be accessed, and as illustrated in FIGS. 3-5, the carrier frame 22 detaches/decouples and/or unlocks from the support arm frame 20 and the spare tire assembly pivots to the open state and the tire carrier frame 22 approaches (and perhaps contacts) the ground or other underlying support surface 26 enabling the user to gain access to the spare tire 24. More particularly, the tire carrier frame securing point 28 detaches from the support arm securing point 30 and the spare tire assembly 16 pivots about the tire carrier pivot point member 32 until the tire carrier frame 22 contacts the ground 26, at which point the spare tire 24 can be removed.

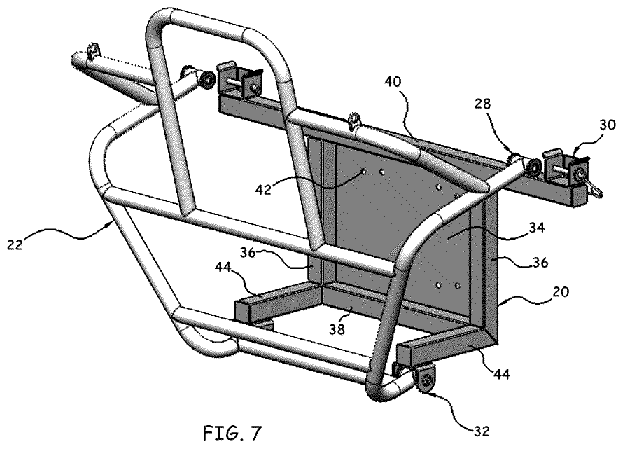

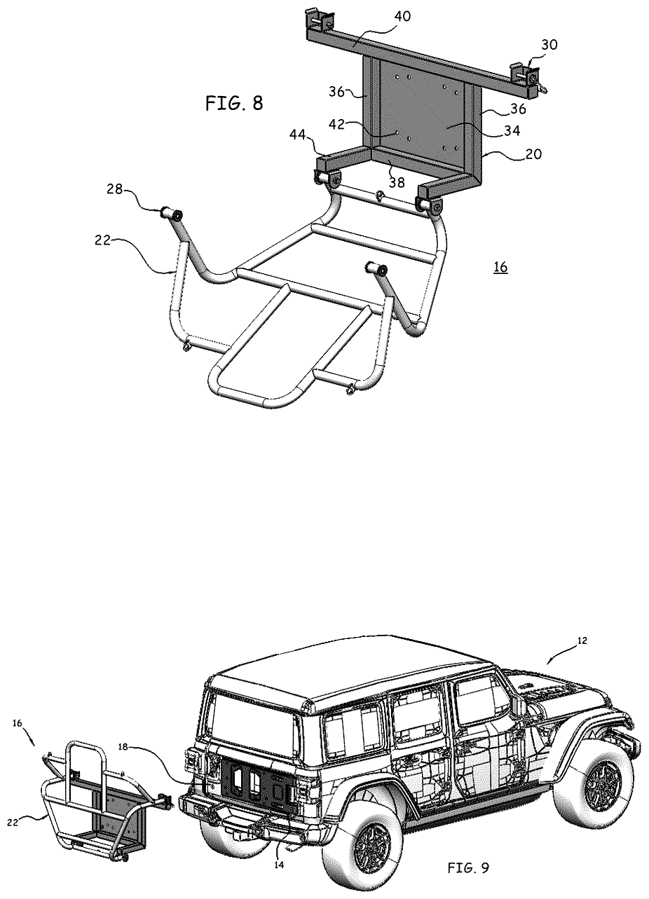

The spare tire assembly 16 will now be detailed in the enlarged views of FIGS. 6-8. First, the support arm frame 20 includes a back plate 34 with two vertical support members 36, a lower support member 38 and an elongated upper support member 40. The back plate having apertures 42 for receiving a bolt, screw or other fastening means for securing the plate 34 to the tailgate support assembly 14. The lower support member having generally horizontally extending arms 44 with tire carrier pivot points 32 near its ends. The upper support 40 having securing points 30 near its ends. Next, the tire carrier frame 22 is preferably sized and shaped to enclose and secure a typical spare tire and/or an enlarged off-road style spare tire. The lower portion of the tire carrier frame 32 is pivotally connected, as in known in the art, to pivot points 32. The upper portion of the tire carrier frame 22 is secured to the support arm securing pint 30 via carrier frame securing point 28. This securing point (28/30) is secured/attached/latched/coupled and/or locked as is known in the art. While the illustrated biased pin lock is shown, it will be appreciated that other mechanisms may be employed. The lower portion pivot point 32 combined with the securing point (28/30) latch allows for the tire to be biased closed when it is in the secured position. This feature aids the tire carrier frame 22 in not wanting to unfold from the support arm frame without the user unlatching it and manually opening it rearward.

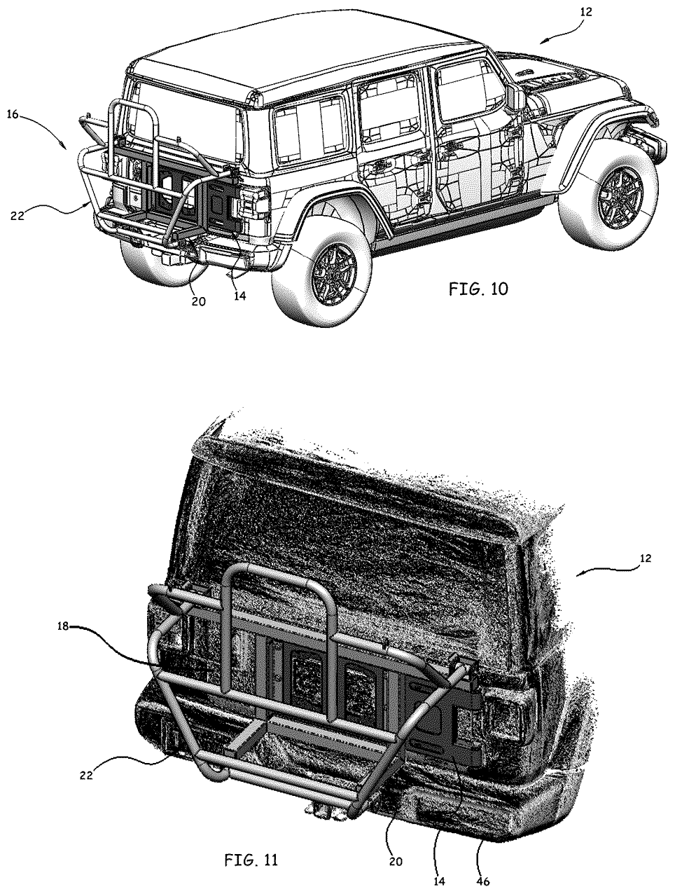

FIG. 9 illustrates the tire assembly 16, with the support arm frame 20 and the tire carrier frame 22, in the latched position ready to be attached to the gate support assembly 14 already affixed to the swing gate 18 of the vehicle 12. While FIG. 10 illustrates the spare tire assembly 16 fastened to the gate support assembly 14. The tireless illustration of FIG. 10, as opposed to FIG. 1, provides a clearer depiction of the positioning of the device 10 vis-a-vi the vehicle 12. Indeed, the enlarged tireless view of FIG. 11 enhances same.

As shown and described, the present disclosure provides a solution for carrying spare tires on vehicles with a rear swing gate or tailgate that allows the user to easily remove/install the spare tire into or onto a carrying device that allows the user to use the gate easily; makes mounting of the spare easy and does not create injury by lifting the weight of the spare tire assembly; and supports the gate for the added weight of the spare tire assembly, especially larger off-road tires. The present disclosure has shown a safe alternative to mounting a spare tire by lifting it in place, as well as being able to have full use of the gate without having to move/disengage anything as a first step.

One of the most beneficial features of the present disclosure is the design that allows the user full use of the tailgate or swing gate. More particularly, and turning back to FIG. 11, a spare tire assembly 22 mounted to a vehicle 12 rear swing gate 18 or tailgate that allows the spare tire carrier assembly to pivot downward or sideways that is only secured to the gate and therefor allowing full use thereof without any previous primary operation. In other words, as the gate support assembly 14 is only attached to the gate 18, and not any other portion of the vehicle (e.g., the vehicle frame or a bumper 46), it can be accessed irrespective of gate position.

In use, the user lowers the empty carrier (for example) by detaching the upper attachment points, installs (perhaps by rolling) the tire into the carrier and secures the spare tire assembly to the carrier. The user then pivots the tire carrier into the stored position and secures the carrier in place. This process is reversed when the spare tire needs to be accessed.

As such, the spare tire assembly mounts to a vehicle rear gate and provides a pivot point that allows the user to open and rest against the ground for ease of tire access. It is the location of the pivot point between the tire carrier and the frame that allows the carrier to pivot without interfering with any vehicle parts (i.e., the bumper 46) and contact (rest upon) the ground. Accordingly, the tire assembly can be opened and closed without interfering with the function of the vehicle gate. Indeed, the gate may be in the closed position, the open position or anywhere in-between and the carrying device will nevertheless function as designed.

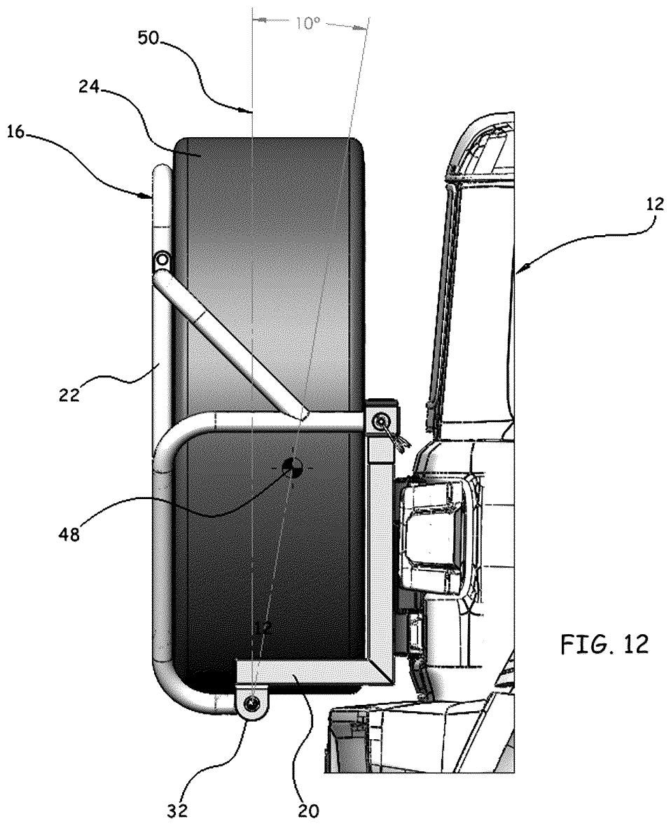

It will be appreciated that alternate embodiments of the present disclosure may be implemented, including, but not limited to those illustrated in FIGS. 12-14. Turning first to FIG. 12, the alternate tire assembly 16 design includes a support arm frame 20 and a tire carrier frame 22 that together with the tire create a center of mass 48 between the vehicle 12 and the vertical pivot centerline 50 originating from the pivot point 32. As such, the moving assembly is biased or urged in the closed position (until it is pivoted rearward past the pivot centerline).

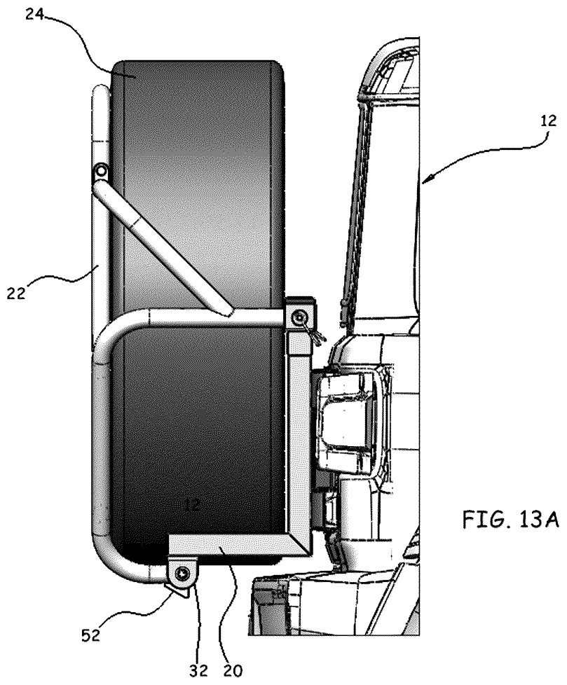

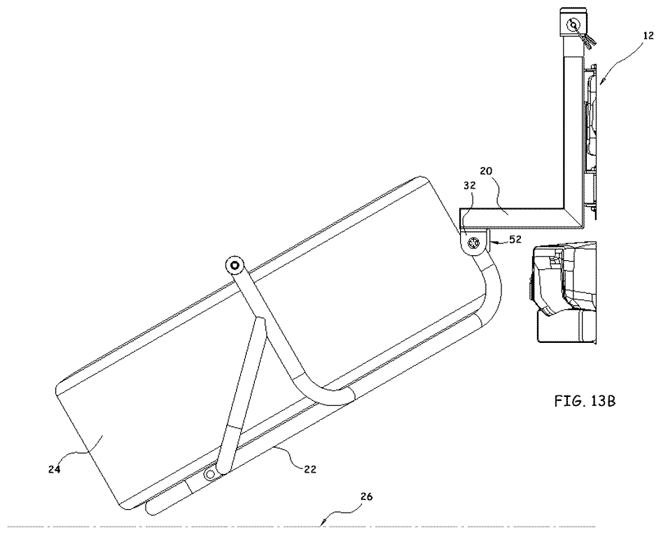

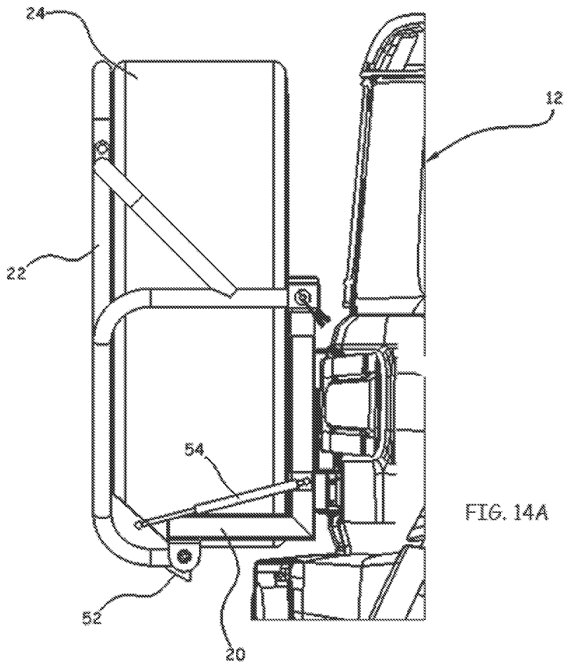

Rather than opening the tire frame assembly to rest on an underlying support surface, the alternate embodiment of FIGS. 13A and 13B illustrate the assembly resting on support arms. In particular, FIG. 13A shows the assembly in the closed position and a stop member 52 affixed to the tire carrier frame 22. In the open position of FIG. 13B, the stop 52 contacts the support arm 20 and prevents further rotation so as to not contact the underlying support surface 26. It will be understood that the stop 52 may be affixed to the support 20 (or otherwise affixed) instead of the tire carrier frame 22.

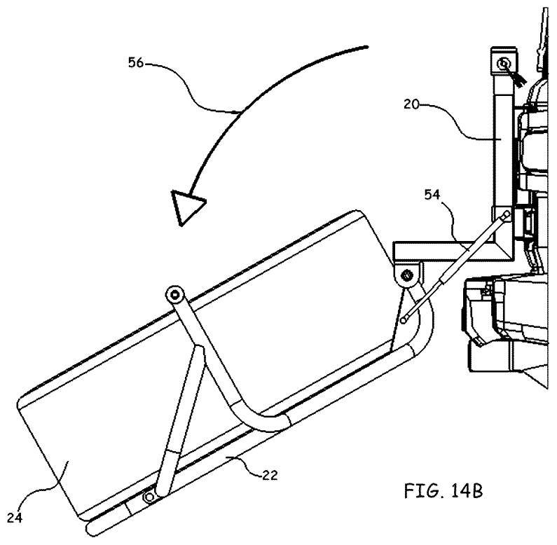

Rather than manually manipulating the weight of the assembly and tire upon opening, FIGS. 14A and 14B illustrate a speed control device to slow rotation and provide safety. In particular, FIG. 14A shows the assembly in the closed position and a speed control device 54 (in this case a piston assembly) affixed to both the support arm frame 20 and the tire carrier frame 22. This speed control device can be used to slow the downward movement/rotation 56 of the tire carrier assembly. It will be understood that the speed control device can take numerous other forms, including but not limited to mechanical springs, gas springs, struts, etc.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

What is claimed is:

1. A device for carrying a spare tire on a vehicle rear gate, the device comprising:
a tire assembly coupled to said gate;
said assembly shaped to enclose said tire and having an open position and a closed position;
a securing mechanism for securing said assembly in said closed position;
a pivot member for opening said assembly to said open position; and
wherein said pivot member is positioned to allow full access of said gate regardless of tire assembly position.

2. The device as defined in claim 1 wherein said tire assembly includes a support arm frame and a tire carrier frame.

3. The device as defined in claim 2 wherein said securing mechanism secures said support arm frame to said tire carrier frame.

4. The device as defined in claim 2 wherein said support arm frame and said tire carrier frame are pivotally connected.

5. The device as defined in claim 1 further including a gate support assembly.

6. The device as defined in claim 2 wherein said support arm frame includes an extending arm whereby said pivot member is positioned near an extending arm end.

7. The device as defined in claim 1 wherein said tire assembly contacts an underlying support surface when open.

8. The device as defined in claim 1 wherein said securing means in near a top of said assembly and said pivot member is near a bottom of said assembly.

9. The device as defined in claim 1 wherein said device has a center of gravity that urges said assembly in said closed position.

10. The device as defined in claim 1 further having a stop member that stops the pivoting of the assembly.

11. The device as defined in claim 1 further having a speed control device for controlling the speed of opening said assembly.
